(19) United States
(12) Patent Application Publication
(10) Pub. No.: US 2019/0232371 A1
(43) Pub. Date: Aug. 1, 2019

(54) Layer-by-layer manufacturing method and layer-by-layer manufacturing apparatus for the additive production of at least one region of a component

(71) Applicant: MTU Aero Engines AG, Muenchen (DE)

(72) Inventors: Alexander LADEWIG, Bad Wiessee (DE); Joachim BAMBERG, Dachau (DE); Andreas JAKIMOV, Fahrenzhausen (DE); Sebastian ROTT, Muenchen (DE); Steffen SCHLOTHAUER, Erdweg (DE); Daniel GREITEMEIER, Herbertshausen (DE); Michael SCHACHER, Weisendorf (DE)

(21) Appl. No.: 16/258,839

(22) Filed: Jan. 28, 2019

(30) Foreign Application Priority Data
Jan. 29, 2018 (DE) 102018201255.5

(51) Int. Cl. B22F 3/105; B22F 5/00; B23K 26/03; B23K 26/342

(52) U.S. Cl. CPC B22F 3/1055; B22F 5/00; B33Y 10/00; B23K 26/342; B23K 26/032

(57) ABSTRACT

A layer-by-layer manufacturing method for the additive production of a region of a component, in particular of a turbomachine. The layer-by-layer manufacturing method includes: a) depositing a powder layer of a material onto a buildup and joining zone of a lowerable build platform; b) locally solidifying the material to form a component layer by selectively irradiating the material using an energy beam in accordance with a predetermined exposure strategy; c) lowering the build platform layer-by-layer by a specified layer thickness; and d) repeating the steps a) through c) until completion of the component region. Following at least one of the steps a) through c), a monitoring system ascertains and evaluates a result of the respective step; at least one intermediate correction step e) is executed for improving the ascertained result when the evaluation reveals an unacceptable deviation from a result specified for the respective step. Also, a corresponding layer-by-layer manufacturing apparatus.

This claims the benefit of German Patent Application DE102018201255.5, filed Jan. 29, 2018 and hereby incorporated by reference herein.

The present invention relates to a layer-by-layer manufacturing method for the additive production of at least one region of a component. The present invention also relates to a layer-by-layer manufacturing apparatus for the additive production of at least one region of a component using an additive layer-by-layer manufacturing method.

### BACKGROUND

Additive layer-by-layer manufacturing methods refer to processes where geometric data are determined on the basis of a virtual model of a component or component region to be manufactured and are broken down into layer data (generally referred to as “slices”). An exposure strategy for selectively solidifying a material is determined as a function of the geometry of the model. Besides the number and configuration of exposure vectors, for example, strip exposure, island strategy, etc., the exposure strategy includes other process parameters, such as, for example, the power of a high-energy beam to be used for the solidification, as well as the partitioning into what are generally referred to as up-, in- and down-skin areas. In accordance with the exposure strategy, the desired material is then deposited layer-by-layer and selectively solidified by at least one high-energy beam, to additively build up the component region. Thus, additive, respectively generative manufacturing methods differ from conventional material-removal or primary forming manufacturing methods. Examples of additive production methods include generative laser sintering, respectively laser melting methods that can be used for manufacturing components for turbomachines, such as aircraft engines. In selective laser melting, thin powder layers of the material(s) used are deposited on a build platform and locally melted and solidified in the area of a buildup and joining zone with the aid of one or a plurality of laser beams. The build platform is subsequently lowered, another powder layer deposited and locally solidified again. This cycle is repeated until the finished component, respectively the finished component region is obtained. The component may subsequently be further processed as needed or used without further machining steps. In selective laser sintering, the component is produced in a similar manner by the laser-assisted sintering of pulverulent materials.

A multitude of sensors is typically used to monitor and document these types of layer-by-layer manufacturing methods. On the basis of the existing data, the result of the build is often evaluated afterwards, i.e., subsequently to the completion of the desired component or component region. However, if an unacceptable process disturbance occurs at that moment, a defect is already introduced into the built-up component, which, generally, cannot be repaired later. The manufactured component is thus rejected. To avoid defective components, what are generally referred to as “closed-loop” controls exist, where the exposure step, respectively solidification step is monitored, and the aim is to directly readjust the process parameters, as soon as a process disturbance is recognized.

In the known layer-by-layer manufacturing methods and apparatuses, the circumstance is considered to be disadvantageous whereby directly readjusting the process parameters during the exposure step is comparatively complex and error-prone and, even if successful, only a relatively small share of all possible process disturbances is detected, so that the proportion of defective components can only be insufficiently reduced in this manner.

### SUMMARY OF THE INVENTION

It is an object of the present invention to improve a layer-by-layer manufacturing method and a layer-by-layer manufacturing apparatus of the type mentioned at the outset in a way that makes possible a better process control and a reduction of process disturbances. Another object of the present invention is to provide a storage medium having a program code, which ensures an appropriate control of such a layer-by-layer manufacturing apparatus.

The present invention provides a layer-by-layer manufacturing method, by a layer manufacturing apparatus, and a storage. Advantageous embodiments including useful refinements of the present invention are delineated below, whereby advantageous embodiments of each inventive aspect are to be considered as advantageous embodiments of the respective other inventive aspects.

A first aspect of the present invention relates to a layer-by-layer manufacturing method for additively producing at least one region of a component, in particular of a component of a turbomachine. The layer-by-layer manufacturing method includes at least the steps of: a) depositing at least one powder layer of a material (W) onto at least one buildup and joining zone of at least one lowerable build platform; b) locally solidifying material (W) to form a component layer by selectively irradiating material (W) using at least one energy beam in accordance with a predetermined exposure strategy; c) lowering the build platform layer-by-layer by a specified layer thickness; and d) repeating steps a) through c) until completion of the component region. The present invention makes it possible to improve process control and reduce process disturbances by employing a monitoring system that ascertains and evaluates a result of the respective step following at least one of steps a) through c), whereby at least one intermediate correction step e) is executed for improving the ascertained result when the evaluation reveals that the ascertained result deviates unacceptably from a result specified for the respective step. In other words, in accordance with the present invention, once at least one of the three process steps a) through c) (a) deposition, b) solidification, c) lowering) has ended, the result (output) of respective process step a), b) and/or c) is controlled by the result being ascertained and assessed by the monitoring system to determine whether it corresponds to a desired result for the particular step, respectively is within acceptable deviations. Once the result (output) of each step a) through c) is manifested at least as a precondition (input) for implementing respective subsequent step (b), c) and/or d)), as a function of the specific requirements, it may be thereby ensured that not only possible solidification defects, but also other process deviations and material defects are reliably ascertained, evaluated and, in the case of unacceptable deviations, eliminated within the scope of respective intermediate correction step e). This prevents a subsequent process step b), c) and/or d) from being performed with a faulty “input,” which would cause additional defects. Besides reducing the amount of rejected material, this also makes it possible to cut down on inspection times since, with the aid of the monitoring system, the ascertainment, assessment, and correction may be carried out as automated processes, respectively without manual interventions. Thus, even complex components may be reliably manufactured. As a general principle, merely the result of one of steps a) through c) may be ascertained and assessed by the monitoring system. Preferably, however, the result of at least two of steps a), b), c) and, preferably, of all three steps a) through c) is ascertained and assessed to achieve an especially reliable process control accompanied by a correspondingly high build quality and reliable avoidance of rejected material. Furthermore, it is fundamentally possible that the result of at least one of the steps a) through c) is ascertained, assessed and, if indicated, corrected in a corresponding step e) for only one component layer, for a plurality of component layers, or for all component layers. Actions, which lead, respectively may lead to an improvement in the ascertained result in accordance with the specified result, are generally taken within the scope of intermediate correction step e). If, subsequently to step a), for example, an insufficient deposition of the powder layer is ascertained, the powder layer may be deposited once again within the scope of intermediate correction step e). If, subsequently to step b), an inadequate surface quality of the manufactured component layer is determined, a repeated rewelding and/or a mechanical removal of excess material may be carried out as a function of the defect within the scope of intermediate correction step e). If it is determined after step c) that the build platform has been lowered incorrectly, it may be repositioned, for example, in the course of intermediate correction step e) to ensure that it move exactly by the specified layer thickness, etc. In the context of the present disclosure, “a/an” are generally to be read as indefinite articles and always also as “at least one,” unless expressly stated otherwise. Conversely, “a/an” may also be understood to mean “only one.”

Following the at least one intermediate correction step e), the present invention provides that the monitoring system ascertain and evaluate a result of the respective intermediate correction step e), whereby the intermediate correction step e) is repeated to improve the ascertained result when the evaluation still reveals that the ascertained result deviates unacceptably from the result specified for the respective step. In other words, even the result of a potential intermediate correction step e) is controlled and checked for the attainment of the specified result. If the predetermined result is not or not sufficiently reached even following intermediate correction step e), intermediate correction step e) is repeated, whereby even serious process errors, as well as process disturbances, which occur during intermediate correction step e) itself, are reliably recognized and may, if indicated, be subject to a repair, respectively correction, that is repeated once or several times.

Another advantageous embodiment of the present invention provides that ascertaining the result employing the monitoring system include examining the powder layer and/or at least one component layer to check for process deviations. This makes it possible to recognize process disturbances in connection with the unsolidified powder and/or in connection with one or a plurality of solidified component layers, and for correction to be performed as needed.

Another advantageous embodiment of the present invention provides that examination of the powder layer include checking for at least one process deviation from the group that includes contamination, unacceptable material accumulation, and insufficient deposition of the powder layer, and/or that examination of the at least one component layer include checking for at least one process deviation from the group that includes balling, unacceptable material deposits, variation in the melt trace, cracking, material defect and lack-of-fusion defects. To this end, the monitoring system may include every suitable component, respectively use every suitable component that makes it possible to detect irregularities of the powder layer and/or of at least one component layer. If there is an insufficient deposition of the powder layer, a potential intermediate correction step e) may then include repeating the powder deposition using a defined, if indicated, decreased metered dose of powder material. For example, if only ¾ of the build platform is coated, intermediate correction step e) merely needs to use about half or less of the normal metered dose of powder material, as ¾ of the desired surface is already coated. Conversely, if there is excess powder material, the excess powder may be suitably removed. Process disturbances of the at least one component layer may lead, for example, to surface irregularities, such as balling effects, material accumulations, or other melt trace variations. Such surface irregularities may be ascertained, for example, by measuring a height profile or the surface structure. If unacceptable deviations are detected, which may arise, for example, by the solidification step being disturbed, by deposits of powder residue or material, a suitable repair step, respectively correction step is executed as intermediate correction step e) before the further process sequence is continued.

Further advantages will become apparent as examining the at least one component layer to check for process deviations includes examining at least one surface region of a component layer situated in a current build plane and/or examining at least one component layer situated underneath the current build plane. Surface defects and/or defects, which are located one or a plurality of layers underneath the current build plane, i.e., within the already manufactured component region, may hereby be selectively ascertained and assessed.

Further advantages are derived from the layer-by-layer manufacturing method being interrupted in response to a specified number of repetitions of the intermediate correction step e) in question being reached or exceeded and/or in response to the deviation of the ascertained result from the result specified for the respective step being evaluated as not possible to eliminate. In other words, the layer-by-layer manufacturing method is interrupted even when the desired result is not attainable by repeating intermediate correction step e) once or several times, and/or when the assessment of the ascertained result establishes that, from the outset, a successful repair or correction is not promising or is at least very improbable. This at least makes it possible to prevent a defective component from being completed unnecessarily.

Another advantageous embodiment of the present invention provides that intermediate correction step e) include repeating step a), b) and/or c) in question using identical and/or modified process parameters, and/or that the intermediate correction step e) includes an operational step that deviates from step a), b) and/or c) in question. The most promising or the absolutely necessary intermediate correction step e) may be hereby selected and implemented in each case as a function of the assessment of the ascertained result. For example, in the case of disturbances of a melting process (step b)), what are generally referred to as balling effects frequently occur, which refer to ball formations of the molten pool on the welded surface. Such balling effects may be ascertained, for example, by optical tomography or using other suitable components to qualify the result of step b). Upon building up the next component layer, the balls formed on the surface lead in many cases to lack-of-fusion defects. Therefore, upon detection of such a process disturbance in intermediate correction step e), these resulting balling effects on the surface are removed or melted prior to continuation of the layer-by-layer manufacturing method. This may take place, for example, by repeated rewelding using the same parameters or parameters that are optimized for a smoothing (for example, power, hatching, speed, if indicated, focus position). Alternatively or additionally, a coater blade may be used for mechanically removing the balls in intermediate correction step e).

Another advantageous embodiment of the present invention provides that the monitoring system ascertain the result of at least one of steps a) through c) using a thermal imaging camera and/or an optical tomography device and/or a powder bed monitoring device and/or an eddy-current testing and/or an X-ray inspection device, in particular using computer tomography. This enables the monitoring system to check for process disturbances flexibly and reliably.

Further advantages are derived from the specified result being determined on the basis of a master model and stored in a data storage. In other words, it is provided that the result to be specified for respective step a), b) and/or c) for a particular component layer be stored in a data storage on the basis of a master model, which may also be referred to as a reference component, and be used to assess the results ascertained in each particular case of the individual build jobs. The master model itself may be established on the basis of comprehensive tests. This ensures that data found to be good constitute the basis for assessing the individual build jobs, without each individual component having to undergo the same extensive tests as the master model.

A second aspect of the present invention relates to a layer-by-layer manufacturing apparatus for additively producing at least one region of a component using an additive, layer-by-layer manufacturing method. The layer-by-layer manufacturing apparatus includes at least a powder feed for depositing at least one powder layer of a material (W) onto a buildup and joining zone of a movable build platform, at least one radiation source for generating at least one energy beam for the layer-by-layer and local solidification of material (W) to form a component layer by selectively irradiating material (W) in accordance with a predetermined exposure strategy, and a control device. The control device is designed to thereby control the powder feed in a step a) to deposit at least one powder layer of material (W) onto the buildup and joining zone of the build platform and thereby control the radiation source in a step b) to generate the energy beam and solidify material (W) to form the component layer layer-by-layer and locally in accordance with a predetermined exposure strategy through selective irradiation, and to lower the build platform in a step c) layer-by-layer by a specified layer thickness. In accordance with the present invention, the layer-by-layer manufacturing apparatus also includes at least one monitoring system, which, for purposes of data exchange, is coupled to the control device and is designed to ascertain and evaluate a result of the step in question following at least one of steps a) through c); whereby the monitoring system controls at least one component in such a way that this component executes at least one intermediate correction step e) to improve the ascertained result when the evaluation yields that the ascertained result deviates unacceptably from a result specified for the respective step. In other words, the present invention provides that the layer-by-layer manufacturing apparatus include a monitoring system, which, once at least one of the three process steps a) through c) (a) deposition, b) solidification, c) lowering) has ended, the result (output) of respective process step a), b) and/or c) is controlled by the result being ascertained and assessed by the monitoring system to determine whether it corresponds to a desired result for the particular step, respectively is within acceptable deviations. Once the result (output) of each step a) through c) is manifested at least as a precondition (input) for implementing respective subsequent step (b), c) and/or d)), it may be thereby ensured, as a function of the specific requirements, that not only possible solidification defects, but also other process deviations and material defects are reliably ascertained, evaluated and, in the case of unacceptable deviations, eliminated within the scope of respective intermediate correction step e). This prevents a subsequent process step b), c) and/or d) from being performed with a faulty “input,” which would cause additional defects. Besides reducing the amount of rejected material, this also makes it possible to cut down on inspection times since, with the aid of the monitoring system, the ascertainment, assessment, and correction may be carried out as automated processes, respectively without manual interventions. Thus, even complex components may be reliably manufactured.

The control device and/or the monitoring system may generally feature a processor device that is adapted for controlling, respectively regulating implementation of the method steps mentioned. To this end, the processor device may have at least one microprocessor and/or at least one microcontroller. Moreover, the control device and/or the monitoring system may feature a storage medium having a program code which, upon execution, is adapted for implementing the method steps in question. The program code may be stored in a data storage of the processor device and/or of the monitoring system. Moreover, the control device and/or the monitoring system may feature a storage medium having a program code which is adapted for implementing a specific embodiment of the layer-by-layer manufacturing method in accordance with the first inventive aspect. Moreover, it may be provided that the monitoring system be controlled and/or regulated by the control device. Conversely, it may also be provided that the monitoring system control and/or regulate the control device. Other advantages are to be inferred from the descriptions of the first inventive aspect. Advantageous embodiments of the first inventive aspect are to be considered as advantageous embodiments of the second inventive aspect. Conversely, advantageous embodiments of the second inventive aspect are to be considered as advantageous embodiments of the first inventive aspect. The layer-by-layer manufacturing apparatus is preferably designed for implementing a layer-by-layer manufacturing method in accordance with the first inventive aspect.

An advantageous embodiment of the present invention provides that the layer-by-layer manufacturing apparatus be designed as a selective laser sintering and/or laser melting apparatus. Component regions may be hereby manufactured whose mechanical properties at least substantially correspond to those of the component material. A CO₂ laser, Nd:YAG laser, Yb fiber laser, diode laser or the like may be provided, for example, to produce a laser beam. It may likewise be provided for two or more laser beams to be used. Upon irradiation, a fusion and/or sintering of the powder may occur as a function of the component material and the exposure strategy, so that, in the context of the present invention, the term “welding” may also be understood as “sintering” and vice versa.

Another advantageous embodiment of the present invention provides that the monitoring system be coupled to a data storage, which is used to store at least one result specified for at least one of the steps a) through c) and at least one component layer. Thus, to evaluate an ascertained result, the monitoring system merely needs to access the local and/or remote data storage, retrieve the result specified for the respective step and the respective component layer, and use it to evaluate the ascertained result. The specified result may be stored in any suitable data format in the data storage. For example, a layer thickness value that possibly includes permissible deviations, may be stored for a specified layer thickness of the powder layer. A (thermographic or tomographic) image of a corresponding component layer of a master model may be stored as a result specified for the assessment of a solidification step b). However, other data may also be provided that characterize the desired result for a respective step.

A third aspect of the present invention relates to a storage medium having a program code that, when executed by a control device, is configured to control a layer-by-layer manufacturing apparatus in accordance with the second inventive aspect to implement a layer-by-layer manufacturing method in accordance with the first inventive aspect. The resulting features and the advantages thereof can be inferred from the descriptions of the first and second aspect of the present invention; whereby advantageous embodiments of the first and second inventive aspect are to be considered as advantageous embodiments of the third inventive aspect and vice versa.

### BRIEF DESCRIPTION OF THE DRAWINGS

Other features of the present invention will become apparent from the claims, the figures, and the detailed description. The features and feature combinations mentioned above in the description, as well as the features and feature combinations mentioned below in the detailed description and/or shown in isolation in the figures may each be used not only in the indicated combination, but also in other combinations, without departing from the scope of the present invention. Thus, embodiments of the present invention that are not explicitly shown and explained in the figures, but derive from and can be produced from the explained embodiments using separate feature combinations, are also considered to be included and disclosed herein. In addition, embodiments and combinations of features that therefore do not have all of the features of an originally formulated independent claim are also considered to be disclosed herein. Moreover, in particular by the above explanations, variants and feature combinations are also considered to have been disclosed herein that go beyond or deviate from the feature combinations described in the antecedent references to the claims. In the drawing,

FIG. 1 shows an image of a faulty component layer;

FIG. 2 shows an image of a surface of the faulty component layer;

FIG. 3 shows an image of the surface of the component layer following execution of an intermediate correction step; and

FIG. 4 shows a schematic representation of a layer-by-layer manufacturing method according to the present invention.

### DETAILED DESCRIPTION

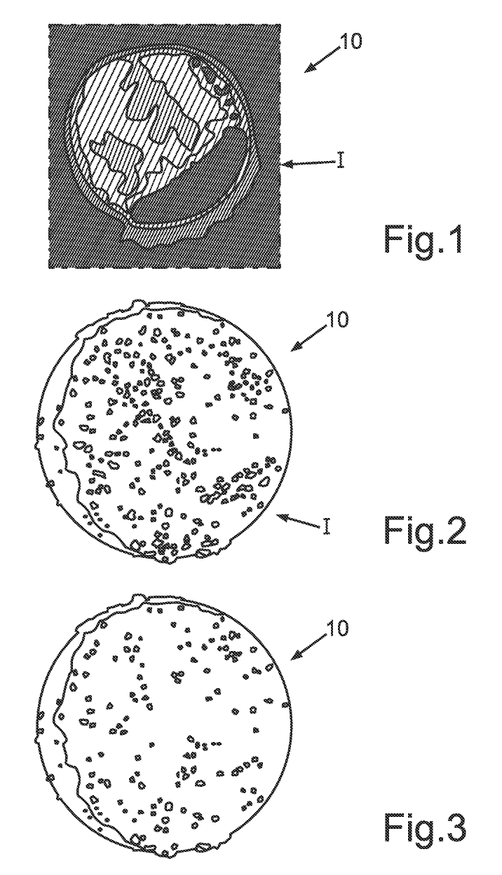

FIG. 1 shows an image of a component layer 10 that was additively manufactured by laser melting using a layer-by-layer manufacturing method; component layer 10 being faulty in the region characterized by arrow I due to a process deviation during the solidification step. The image was created with the aid of an optical tomography device (OT); in principle, other suitable monitoring devices also being usable. Irregularities may arise, for example, due to what are generally referred to as balling effects, material accumulations, insufficient powder deposition, disturbances of the welding process due to powder residue or material deposits or due to melt trace variations.

FIG. 2 shows an image of the surface of the faulty component layer 10; it being discernible that the surface in region I has an unacceptable roughness. The surface structure may be determined, for example, by measuring a height profile. The surface irregularity is primarily based on what are generally referred to as balling effects. In the case of disturbances of the melting process during the solidification step, balling effects occur and include ball formations of the molten pool on the welded surface that may be measured by optical tomography or other monitoring systems to qualify the welding process. When building up the layer of next component layer 10, these balls and other irregularities lead in many cases to lack-of-fusion defects, which results in a degraded joining quality and, in the worst case, to finished component 26, respectively the finished component region becoming rejected material.

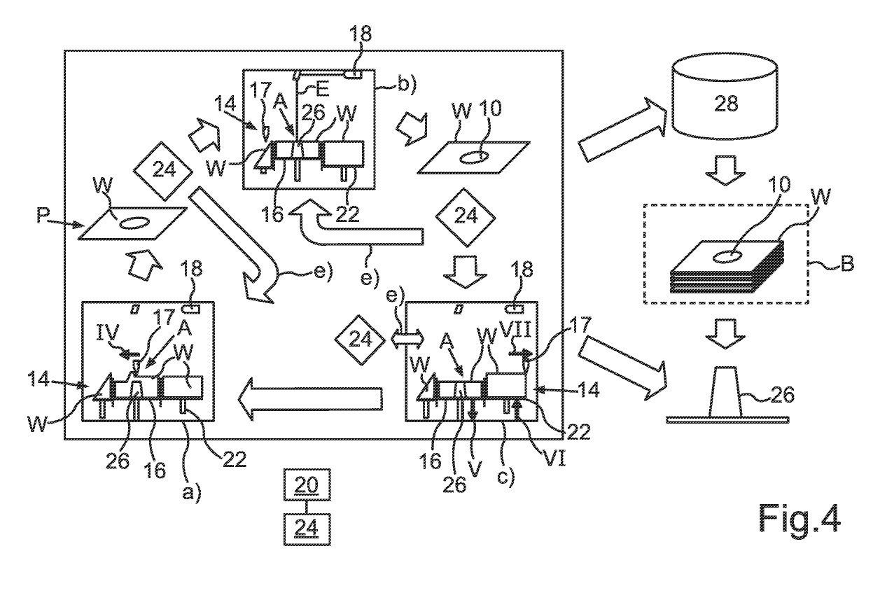

To reduce the amount of rejected material, the present invention provides for a monitoring system 24 (see FIG. 4) to ascertain and evaluate the result of solidification step b), whereby at least one intermediate correction step e) is executed for improving the ascertained result when the evaluation reveals that the ascertained result deviates unacceptably from a result specified for the respective step. In the present case, the intermediate correction step includes repeating the solidification step, i.e., rewelding component layer 10 once or several times. The same parameters or parameters optimized for a smoothing (for example, power, hatching, speed, if indicated, focus position, etc.) may fundamentally be used. It may also be provided that a coater blade 17 or other suitable components be used for mechanically removing the surface irregularities, as explained in greater detail in connection with FIG. 4.

FIG. 3 shows an image of the surface of component layer 10 following execution of the intermediate correction step. It is discernible that the surface is substantially evened out by the rewelding process and is thus a good base for a subsequent layer build-up. If the surface variations that arise during the faulty welding process are completely removed and/or remelted, no material defects arise in the further build-up process. In addition to an enhanced joining quality, the amount of rejected material is also considerably reduced or even completely avoided.

FIG. 4 shows a schematic representation of a layer-by-layer manufacturing method according to the present invention that is implemented with the aid of a layer-by-layer manufacturing apparatus according to the present invention. The layer-by-layer manufacturing apparatus, which is configured here as a laser melting or laser sintering apparatus and, for the sake of clarity, is not shown in the totality thereof, includes a powder feed 14 for depositing at least one powder layer P of a material (W) onto a buildup and joining zone A of a movable build platform 16 in accordance with a coating step a). In the present case, powder feed 14 features a fundamentally optional coater blade 17, which, in accordance with arrow IV, is moved over powder layer P and may be used to even out powder layer P and remove excess material powder.

The layer-by-layer manufacturing apparatus also includes at least one radiation source 18, which, in a solidification step b), produces at least one energy beam E for the layer-by-layer and local solidification of material W. A component layer 10 may be hereby produced by selectively irradiating material W in accordance with a predetermined exposure strategy. In the present case, radiation source 18 is configured as a laser device; it also being alternatively or additionally possible for one or a plurality of electron beam sources to be provided.

In addition, the layer-by-layer manufacturing apparatus features a control device 20. Control device 20 is designed to thereby control powder feed 14 in step a) to deposit a powder layer P of material W onto buildup and joining zone A of build platform 16. In the context of the present disclosure, the concept “control” may also be fundamentally understood as “regulate.” In addition, control device 20 thereby controls, respectively regulates radiation source 18 in step b) to produce energy beam E and solidify material W to form component layer 10 layer-by-layer and locally in accordance with the predetermined exposure strategy through selective irradiation. In a step c), control device 20 subsequently lowers build platform 16 in accordance with arrow V layer-by-layer by a specified layer thickness. It may thereby be optionally provided for a powder reservoir 22 to be raised in accordance with arrow VI relative to build platform 16. In principle, however, other types of powder deposition are also possible. Coater blade 17 moved into a start position in accordance with arrow VII may subsequently be used again in a new pass in accordance with step a) to deposit a new powder layer P. The implementation of steps a) through c) continues until a component 26 or one of the regions thereof is completed.

To recognize and eliminate process disturbances, the layer-by-layer manufacturing apparatus includes a monitoring system 24, which is coupled to control device 20 for the sake of data exchange and, is designed to determine a result of respective step a), b) and/or c) following at least one of steps a) through c) and to evaluate the same on the basis of a result specified for the respective step. It is not absolutely necessary that monitoring system 24 and control device 20 be separate components, as indicated in FIG. 4. Monitoring system 24 controls at least one component of the layer-by-layer manufacturing apparatus as a function of the evaluation in such a way that this component executes at least one intermediate correction step e) to improve the ascertained result when the evaluation reveals that the ascertained result deviates unacceptably from the result specified for the respective step. The component may include or be constituted of powder feed 14, coater blade 17, build platform 16 and/or radiation source 18, for example.

As is discernible in FIG. 4, in the illustrated exemplary embodiment, powder layer P is ascertained and assessed with the aid of monitoring system 24 subsequently to step a). If powder layer P is evaluated as being correctly deposited (“in order”), the method is continued in step b). If powder layer P is evaluated as not being in order (“not in order”), a first intermediate correction step e) is carried out to correct, respectively repair powder layer P. In the simplest case, in the case of insufficient coating, intermediate correction step e) may provide for repeating the powder deposition in accordance with step a) using a defined metered dose of material W. For example, if only ¾ of the buildup and joining zone A is correctly coated, only about half or less of the normal metered dose needs to be used for intermediate correction step e).

Following step b), solidified component layer 10 is ascertained and evaluated accordingly with the aid of monitoring system 24. In the case of disturbances of the melting process, what are generally referred to as balling effects occur, which characterize a ball formation of the molten pool on the welded surface and which—as explained above—may be measured by optical tomography or other monitoring systems to qualify the welding process. When the evaluation of manufactured component layer 10 necessitates performing a suitable intermediate correction step e), component layer 10 may be corrected, for example, by a one-time or repeated rewelding using the same parameters or parameters that are optimized for a smoothing (for example, power, hatching, speed, if indicated, focus position). It may also be provided that coater blade 17 be used to mechanically smooth the surface.

Material defects, such as cracks, pores and lack-of-fusion defects, may generally occur in layer-by-layer manufacturing methods. In principle, it is possible to detect these defects using various inspection techniques. Thus, a material separation (lack-of-fusion defect) may even be detected a few layers (<5-10 layers) underneath the current build plane using thermographic methods, for example. Other methods, such as eddy-current testing for detecting cracks or online X-ray computed tomography methods are also suited for ascertaining and evaluating a certain region underneath the current build plane. However, if any material defects detected during the layer-by-layer manufacturing process are not immediately reacted to, and the build-up is simply continued, the defect remains in the material, and component 26 becomes rejected material, provided that a certain magnitude or criticality is associated with the defect.

If an actual defect is detected in already solidified component 26 a few (1-10) layers beneath the current build plane, then, as intermediate correction step e), the site in question may be remelted again by radiation source 18 or using an additional repair radiation source (not shown) with the aid of adapted parameters. It is necessary to thereby select the parameters in a way that will allow the welding penetration depth of energy beam E to reach the depth of the defect in order to repair the lack-of-fusion defect or joining defect at the site in question. For example, if a lack-of-fusion defect is detected n layers (n=1 through 10) underneath the current build plane, subsequent intermediate correction step e) must remelt component layers 10 to at least a depth of n+1, n+2 or n+3 in order to eliminate the defect. The layer-by-layer manufacturing method may subsequently be normally continued.

In the present exemplary embodiment, to evaluate the result determined for respective component layer 10, monitoring system 24 accesses a data storage 28, in which reference data for respective component layer 10 are stored. The reference data are thereby established on the basis of a verified master model or reference model. Generally, it may also be provided that monitoring system 24 perform the evaluation without any reconciliation with actual measured data, rather, for example, only on the basis of theoretically ascertained model data. In addition, the ascertained results of current build job B may be stored in data storage 28, for example, for documentation purposes, in order to reevaluate individual component layers 10, respectively finished component 26, or to store respective component layer 10 as a new reference in data storage 28.

It may also be generally provided for each intermediate correction step e) to be evaluated to determine whether the desired improvement of the result has taken place or whether further corrections/repairs are necessary. Should a process disturbance violate a specific critical criterion, so that correction or repair of the respective defect appears to be or is improbable or impossible, monitoring system 24 generally interrupts the further build-up process for concerned component 26.

The parameter values indicated in the documents for defining process and measurement conditions for characterizing specific properties of the subject matter of the present invention are also to be considered as within the scope of the present invention, even in the context of deviations, e.g., due to measurement errors, system errors, DIN tolerances, and the like.

### REFERENCE NUMERAL LIST

10 component layer
14 powder feed
16 build platform
17 coater blade
18 radiation source
20 control device
22 powder reservoir
24 monitoring system
26 component
28 data storage
A buildup and joining zone
B build job
E energy beam
P powder layer
W material
a)-e) method step
I region
IV-VII arrow

1-12. (canceled)

13. A layer-by-layer manufacturing method for additively producing at least one region of a component, the method comprising at least the following steps:
a) depositing at least one powder layer of a material onto at least one buildup and joining zone of at least one lowerable build platform;
b) locally solidifying the material to form a component layer by selectively irradiating material using at least one energy beam in accordance with a predetermined exposure strategy;
c) lowering the build platform layer-by-layer by a specified layer thickness; and
d) repeating steps a) through c) until completion of the component region;
a monitoring system ascertaining and evaluating a result of the respective step following at least one of the steps a) through c); whereby at least one intermediate correction step e) is executed for improving the ascertained result when the evaluation reveals that the ascertained result deviates unacceptably from a result specified for the respective step, wherein, following the at least one intermediate correction step e), the monitoring system ascertains and evaluates a result of the respective intermediate correction step e), the intermediate correction step e) being repeated to improve the ascertained result when the evaluation still reveals that the ascertained result deviates unacceptably from the result specified for the respective step.

14. The layer-by-layer manufacturing method as recited in claim 13 wherein the monitoring system ascertaining the result includes examining the powder layer or at least one component layer to check for process deviations.

15. The layer-by-layer manufacturing method as recited in claim 14 wherein the examination of the powder layer includes checking for at least one process deviation from the group consisting of contamination, unacceptable material accumulation, and insufficient deposition of the powder layer, or the examination of the at least one component layer includes checking for at least one process deviation from the group consisting of balling, unacceptable material deposits, variation in the melt trace, cracking, material defect and lack-of-fusion defects.

16. The layer-by-layer manufacturing method as recited in claim 14 wherein examining the at least one component layer to check for process deviations includes examining at least one surface region of a component layer situated in a current build plane or examining at least one component layer situated underneath the current build plane.

17. The layer-by-layer manufacturing method as recited in claim 13 wherein the layer-by-layer manufacturing method is interrupted in response to a specified number of repetitions of the intermediate correction step e) in question being reached or exceeded, or in response to the deviation of the ascertained result from the result specified for the respective step being evaluated as not possible to eliminate.

18. The layer-by-layer manufacturing method as recited in claim 13 wherein the intermediate correction step e) includes repeating step a), b) and/or c) in question using identical or modified process parameters, or the intermediate correction step e) includes an operational step that deviates from the step a), b) or c) in question.

19. The layer-by-layer manufacturing method as recited in claim 12 wherein the monitoring system ascertains the result of at least one of the steps a) through c) using a thermal imaging camera or an optical tomography device, or a powder bed monitoring device, or an eddy-current testing, or using an X-ray inspection device.

20. The layer-by-layer manufacturing method as recited in claim 19 wherein the monitoring system ascertains the result of at least one of the steps a) through c) using computer tomography.

21. The layer-by-layer manufacturing method as recited in claim 12 wherein the specified result is determined on the basis of a master model and stored in a data storage.

22. The layer-by-layer manufacturing method as recited in claim 12 wherein the component is a turbomachine component.

23. A layer-by-layer manufacturing apparatus for the additive production of at least one region of a component using an additive, layer-by-layer manufacturing method, the apparatus comprising:
at least a powder feed for depositing at least one powder layer of a material onto a buildup and joining zone of a movable build platform;
at least one radiation source for generating at least one energy beam for the layer-by-layer and local solidification of the material to form a component layer by selectively irradiating the material in accordance with a predetermined exposure strategy;
a control device designed to control the powder feed in a step a) to deposit this at least one powder layer of the material onto the buildup and joining zone of the build platform; to control the radiation source in a step b) to produce the energy beam and solidify the material to form the component layer layer-by-layer and locally in accordance with a predetermined exposure strategy through selective irradiation; and to lower the build platform in a step c) layer-by-layer by a specified layer thickness; and
a monitoring system coupled to the control device for data exchange and designed to ascertain and evaluate a result of the respective step following at least one of the steps a) through c); the monitoring system controlling at least one apparatus component in such a way that the apparatus component executes at least one intermediate correction step e) to improve the ascertained result, when the evaluation reveals that the ascertained result deviates unacceptably from a result specified for the respective step, wherein, following the at least one intermediate correction step e), the monitoring system ascertains and evaluates a result of the respective intermediate correction step e), the intermediate correction step e) being repeated to improve the ascertained result when the evaluation still reveals that the ascertained result deviates unacceptably from the result specified for the respective step.

24. The layer-by-layer manufacturing apparatus as recited in claim 23 designed as a selective laser sintering or laser melting apparatus.

25. The layer-by-layer manufacturing apparatus as recited in claim 23 wherein the monitoring system is coupled to a data storage used to store at least one result specified for at least one of the steps a) through c) and at least one component layer.

26. A storage medium having a program code that, when executed by a control device, is configured to control a layer-by-layer manufacturing apparatus to carry out the layer-by-layer manufacturing method as recited in claim 12.

27. The storage medium as recited in claim 26 wherein the apparatus includes at least a powder feed; at least one radiation source; a control device designed to control the powder feed and to control the radiation source and to lower the build platform in; and the monitoring system coupled to the control device for data exchange.
